(19) United States
(12) Patent Application Publication
(10) Pub. No.: US 2024/0047712 A1
(43) Pub. Date: Feb. 8, 2024

(54) COOLING SYSTEM FOR FUEL CELL

(71) Applicant: DENSO CORPORATION, Kariya-city (JP)

(72) Inventor: Takashi YAMADA, Kariya-city (JP)

(21) Appl. No.: 18/488,697

(22) Filed: Oct. 17, 2023

Related U.S. Application Data
(63) Continuation of application No. PCT/JP2022/015893, filed on Mar. 30, 2022.

(30) Foreign Application Priority Data
Apr. 27, 2021 (JP) 2021-074923

(51) Int. Cl. H01M 8/04029; B60L 58/33; H01M 8/04701

(52) U.S. Cl. CPC H01M 8/04029; B60L 58/33; H01M 8/04731; H01M 2250/20

(57) ABSTRACT

A refrigerant flow channel allows a refrigerant for cooling a fuel cell to flow therethrough. A radiator radiates heat from the refrigerant that has passed through the fuel cell. A bypass flow channel bypasses the radiator and allows the refrigerant to flow therethrough. A thermostat valve selects a flow path for the refrigerant between the radiator and the bypass flow channel according to a temperature of the refrigerant. A refrigerant temperature sensor measures the temperature of the refrigerant after passing through the fuel cell. A control unit executes, when a temperature difference between a target temperature of the fuel cell and a temperature detected by the refrigerant temperature sensor is equal to or greater than a predetermined value, a temperature adjustment process to reduce the temperature difference by changing a temperature hysteresis characteristic of the thermostat valve.

### CROSS REFERENCE TO RELATED APPLICATION

The present application is a continuation application of International Patent Application No. PCT/JP2022/015893 filed on Mar. 30, 2022, which designated the U.S. and claims the benefit of priority from Japanese Patent Application No. 2021-074923 filed on Apr. 27, 2021. The entire disclosures of all of the above applications are incorporated herein by reference.

### TECHNICAL FIELD

The present disclosure relates to a cooling system for a fuel cell.

### BACKGROUND

Conventionally, a fuel cell has been used for various apparatuses such as a vehicle.

### SUMMARY

According to an aspect of the present disclosure, a cooling system is used for a fuel cell.

### BRIEF DESCRIPTION OF THE DRAWINGS

The above and other objects, features and advantages of the present disclosure will become more apparent from the following detailed description made with reference to the accompanying drawings. In the drawings:

FIG. 1 is a schematic configuration diagram of a fuel cell system including a cooling system for a fuel cell according to a first embodiment;

FIG. 2 is a schematic block diagram illustrating a control device of the fuel cell system;

FIG. 3 is a diagram illustrating a relationship between a temperature hysteresis characteristic of a thermostat valve and a temperature change in a refrigerant;

FIG. 4 is a diagram illustrating the temperature hysteresis characteristic of the thermostat valve;

FIG. 5 is a flowchart illustrating an example of a temperature adjustment process executed by the control device according to the first embodiment; and

FIG. 6 is a flowchart illustrating an example of a temperature adjustment process executed by a control device according to a second embodiment.

### DESCRIPTION OF EMBODIMENTS

Hereinafter, examples of the present disclosure will be described.

According to an example of the present disclosure, a cooling system for a fuel cell adjusts a temperature of the fuel cell using a thermostat valve and a flow rate regulation valve. This example may require a complicated flow rate control using the thermostat valve and the flow rate regulation valve to adjust the temperature of the fuel cell to a target temperature.

According to an example of the present disclosure, a cooling system is for a fuel cell. The cooling system comprises:
a refrigerant flow channel configured to allow a refrigerant, which is to cool a fuel cell, to flow therethrough;
a radiator configured to radiate heat from the refrigerant that has passed through the fuel cell;
a bypass flow channel configured to bypass the radiator and allow the refrigerant to flow therethrough;
a thermostat valve configured to select a flow path for the refrigerant between the radiator and the bypass flow channel according to a temperature of the refrigerant;
a refrigerant temperature sensor configured to measure a temperature of the refrigerant that has passed through the fuel cell; and
a control unit configured to execute, when a temperature difference between a target temperature of the fuel cell and a temperature detected by the refrigerant temperature sensor is equal to or greater than a predetermined value, a temperature adjustment process to change a temperature hysteresis characteristic of the thermostat valve to reduce the temperature difference.

In this configuration, the temperature difference between the target temperature of the fuel cell and the temperature detected by the refrigerant temperature sensor is reduced by changing the temperature hysteresis characteristic of the thermostat valve. Thus, the configuration does not require a complicated flow rate control using the thermostat valve and the flow rate regulation valve. Therefore, the temperature of the fuel cell can be adjusted to the target temperature without complication.

According to another example of the present disclosure, a cooling system is for a fuel cell. The cooling system comprises:
a refrigerant flow channel configured to allow a refrigerant, which is to cool a fuel cell, to flow therethrough;
a radiator configured to radiate heat from the refrigerant that has passed through the fuel cell;
a bypass flow channel configured to bypass the radiator and allow the refrigerant to flow therethrough;
a thermostat valve configured to select a flow path for the refrigerant between the radiator and the bypass flow channel according to a temperature of the refrigerant;
a refrigerant temperature sensor configured to measure the temperature of the refrigerant that has passed through the fuel cell; and
a control unit configured to, when a temperature difference between a target temperature of the fuel cell and a temperature detected by the refrigerant temperature sensor is equal to or greater than a predetermined value, cause the thermostat valve on a radiator side to be temporarily fully closed or fully opened, and thereafter, execute a temperature adjustment process to reduce the temperature difference.

In a state in which the thermostat valve on the radiator side is fully closed or fully opened, an influence of the temperature hysteresis characteristic of the thermostat valve is reset, and thus the temperature of the fuel cell is easily adjusted. Therefore, it is desirable to reduce the temperature difference between the target temperature and an actual temperature of the fuel cell, after the thermostat valve on the radiator side is temporarily fully closed or fully opened. Accordingly, this configuration does not require a complicated flow rate control using the thermostat valve and the flow rate regulation valve. Thus, the temperature of the fuel cell can be adjusted to a target temperature without complication.

Hereinafter, embodiments according to the present disclosure will be described with reference to the drawings. In the following embodiments, parts that are the same as or equivalent to matters described in a preceding embodiment are denoted by the same reference numerals, and description thereof may be omitted. When only a part of components is described in an embodiment, components described in the preceding embodiment can be applied to other parts of the components. In the following embodiments, the embodiments can be partially combined with each other as long as the embodiments do not cause any trouble in combination, even if the combination is not specified in particular.

### First Embodiment

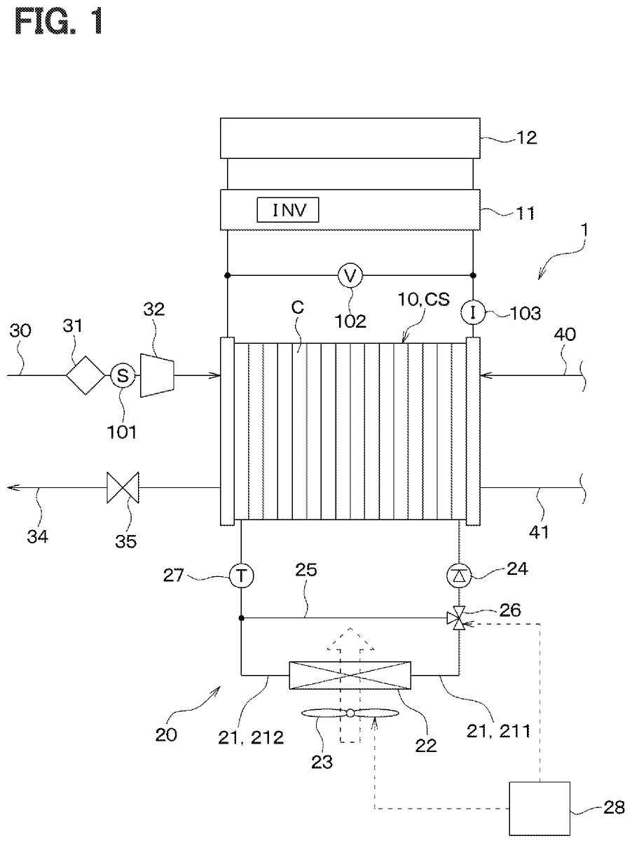

The present embodiment will be described with reference to FIGS. 1 to 5. In the present embodiment, an example will be described in which a cooling system 20 for a fuel cell 10 in the present disclosure is applied to a vehicle FCV that obtains, from the fuel cell 10, electric power supplied to a motor used for vehicle travel. The FCV is an abbreviation for fuel cell vehicle. The cooling system 20 for the fuel cell 10 forms a part of a fuel cell system 1.

The fuel cell system 1 includes the fuel cell 10 that generates electric power by utilizing an electrochemical reaction between hydrogen and oxygen. The fuel cell 10 supplies the electric power to an electric power converter 11 such as an inverter INV. The inverter INV converts a direct current supplied from the fuel cell 10 into an alternating current, and supplies the alternating current to a load device 12 such as a travel motor to drive the load device 12.

Although not illustrated, an electric storage device that stores electric power is connected to the fuel cell 10. The fuel cell system 1 is configured to store surplus electric power among the electric power output from the fuel cell 10 in the electric storage device.

The fuel cell 10 is configured as a cell stack CS obtained by stacking multiple fuel cells C each serving as a minimum unit. The fuel cell C is a solid polymer electrolyte cell (so-called PEFC) including an electrolyte membrane, a catalyst, a gas diffusion layer, and a separator. In the fuel cell C, the electrolyte membrane is sandwiched between the catalyst, the gas diffusion layer, and the separator. In the fuel cell C, when hydrogen is supplied to an anode electrode and oxygen is supplied to a cathode electrode, electrochemical reactions represented by the following reaction formulas F1 and F2 occur, and electric energy is generated.

Anode electrode: H₂→2H⁺+2e⁻ (F1)

Cathode electrode: 2H⁺+½O₂+2e⁻→H₂O (F2)

In order to cause the above electrochemical reactions, the electrolyte membrane of the fuel cell C is required to be in a wet state containing water. In the fuel cell system 1, the electrolyte membrane inside the fuel cell 10 is humidified. The electrolyte membrane can be humidified by disposing a humidifier or the like in a supply path for hydrogen serving as a fuel gas or air serving as an oxidant gas.

The fuel cell system 1 is provided with an air supply path 30 for supplying air containing oxygen to the fuel cell 10. An air filter 31 is provided in the most upstream portion of the air supply path 30, and an air pump 32 is provided downstream of the air filter 31. The air pump 32 forms an oxidant gas supply unit that supplies an oxidant gas to the fuel cell 10. The air pump 32 controls a capacity for supplying air to the fuel cell 10 based on a control signal from a control device 100 to be described later.

The fuel cell system 1 is provided with an air discharge path 34 through which an off gas (that is, off air) of air discharged from the fuel cell 10 flows to a muffler (not illustrated). An air valve 35 is provided in the air discharge path 34. The air valve 35 is a regulation valve that regulates air pressure inside the fuel cell 10.

The fuel cell system 1 is provided with a hydrogen supply path 40 for supplying hydrogen to the fuel cell 10. Although not illustrated, a high-pressure hydrogen tank is provided in the most upstream portion of the hydrogen supply path 40, and a fuel valve is provided downstream of the high-pressure hydrogen tank.

The fuel cell system 1 is provided with a hydrogen discharge path 41 through which an off gas (that is, off fuel) of hydrogen discharged from the fuel cell 10 flows to a muffler (not illustrated). The hydrogen discharge path 41 is provided with an exhaust valve (not illustrated). A downstream side of the hydrogen discharge path 41 is connected to the air discharge path 34. Accordingly, the off fuel flowing through the hydrogen discharge path 41 is mixed with the off air and diluted, and then the mixture is discharged from the muffler.

The fuel cell 10 generates heat by the electrochemical reaction between hydrogen and oxygen. An operating temperature of the fuel cell 10 is required to be maintained at about 80° C. in consideration of power generating efficiency improvement and deterioration restriction of the electrolyte membrane.

The fuel cell system 1 includes the cooling system 20 for adjusting a temperature of the fuel cell 10 to an appropriate temperature. The cooling system 20 adjusts the temperature of the fuel cell 10 by radiating heat from the fuel cell 10 to an outside or supplying heat from the outside to the fuel cell 10 using a refrigerant.

The cooling system 20 includes a refrigerant flow channel 21 through which a refrigerant for cooling the fuel cell 10 flows, a radiator 22, a blower fan 23, a refrigerant pump 24, a bypass flow channel 25, a thermostat valve 26, and a refrigerant temperature sensor 27. The cooling system 20 does not include a flow rate regulation valve for regulating a flow rate of the refrigerant passing through the fuel cell 10.

The refrigerant flow channel 21 forms a circulation circuit that allows the refrigerant to circulate between the radiator 22 and the fuel cell 10. The refrigerant flow channel 21 includes a first flow channel portion 211 that guides the refrigerant that has passed through the radiator 22 into the fuel cell 10, and a second flow channel portion 212 that guides the refrigerant that has passed through the fuel cell 10 into the radiator 22.

The radiator 22 is a radiator that allows the refrigerant that has passed through the fuel cell 10 to radiate heat. The radiator 22 uses outside air as a heat medium and allows the refrigerant to radiate heat by heat exchange with the outside air. The radiator 22 is disposed in the front of the vehicle FCV such that the outside air is introduced when the vehicle FCV is traveling. The radiator 22 is provided in parallel with the blower fan 23.

The blower fan 23 blows the outside air serving as the heat medium toward the radiator 22. The blower fan 23 is disposed close to the radiator 22. The blower fan 23 is formed of an electric fan capable of adjusting a blowing capacity according to an energization amount. The energization amount for the blower fan 23 is adjusted according to a control signal from a control unit 28.

The refrigerant pump 24 pumps the refrigerant into the fuel cell 10. The refrigerant pump 24 is disposed in the first flow channel portion 211 of the refrigerant flow channel 21. An operation of the refrigerant pump 24 is controlled according to a control signal from the control unit 28.

The bypass flow channel 25 is a flow channel which bypasses the radiator 22 and through which the refrigerant flows. One end side of the bypass flow channel 25 is connected to the first flow channel portion 211, and the other end side thereof is connected to the second flow channel portion 212. The thermostat valve 26 is disposed at a connection portion between the bypass flow channel 25 and the first flow channel portion 211.

The thermostat valve 26 selects a flow path for the refrigerant between the radiator 22 and the bypass flow channel 25 according to a temperature of the refrigerant. The thermostat valve 26 includes wax that swells when the temperature of the refrigerant is equal to or higher than a predetermined temperature, and a valve body displaced by the swelling of the wax. When the temperature of the refrigerant is high, the thermostat valve 26 on a radiator 22 side is opened to allow the refrigerant to flow through the radiator 22. When the temperature of the refrigerant is low, the thermostat valve 26 on the radiator 22 side is closed to allow the refrigerant to flow through the bypass flow channel 25.

The refrigerant temperature sensor 27 is a temperature sensor that detects the temperature of the refrigerant immediately after the refrigerant passes through the fuel cell 10. The refrigerant temperature sensor 27 is disposed in the second flow channel portion 212. A temperature Tfc detected by the refrigerant temperature sensor 27 corresponds to the temperature of the fuel cell 10 (that is, an FC temperature).

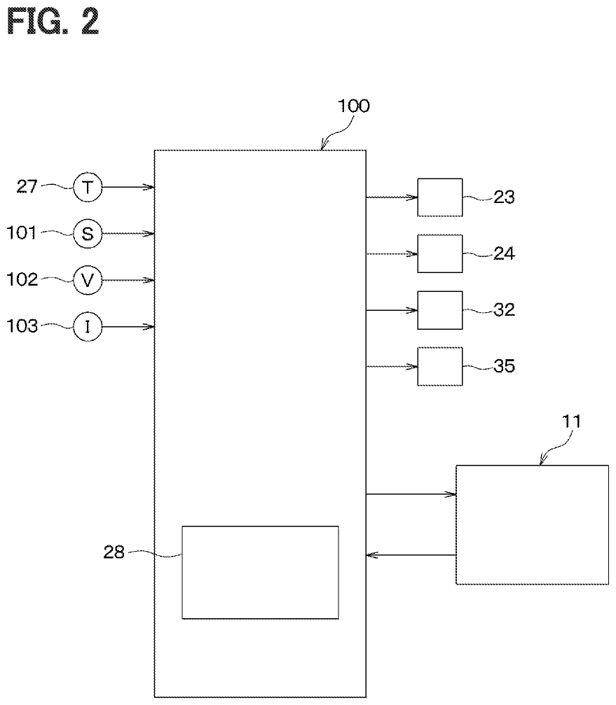

Next, the control device 100 of the fuel cell system 1 will be described with reference to FIG. 2. As illustrated in FIG. 2, the control device 100 controls operations of various control target devices that form the fuel cell system 1. The control device 100 includes a microcomputer including a processor and a memory, and peripheral circuits of the microcomputer. The memory of the control device 100 is a non-transitory tangible storage medium.

The refrigerant temperature sensor 27, an airflow meter 101, an FC voltage detection unit 102, an FC current detection unit 103, and the like are connected to an input side of the control device 100.

The airflow meter 101 is disposed in the air supply path 30. The airflow meter 101 is a sensor that detects a flow rate of air flowing through the air supply path 30.

The FC voltage detection unit 102 and the FC current detection unit 103 are provided on connection lines between the fuel cell 10 and the inverter INV. The FC voltage detection unit 102 is a sensor that detects an output voltage output from the fuel cell 10 (that is, an FC voltage). The FC current detection unit 103 is a sensor that detects a current flowing through the fuel cell 10.

Control target devices such as the blower fan 23, the refrigerant pump 24, the air pump 32, the air valve 35, and the fuel valve (not illustrated) are connected to an output side of the control device 100. The electric power converter 11 such as the inverter INV is connected to the control device 100. The control device 100 controls an operation of the fuel cell 10 by operating the control target devices connected to the output side based on a control program stored in the memory.

The control device 100 includes the control unit 28 that controls the blower fan 23 and the refrigerant pump 24, which are control target devices in the cooling system 20. The control unit 28 forms a part of the cooling system 20. The control unit 28 controls the blower fan 23 and the refrigerant pump 24 that are included in the cooling system 20.

In the fuel cell system 1 having such a configuration, operations of the control target devices connected to the output side are controlled by the control device 100 such that electric power is output according to electric power requested from the load device 12 such as a travel motor.

When the electric power requested for the fuel cell 10 is low, the control device 100 controls a capacity of the air pump 32 and an opening degree of the fuel valve so as to reduce a supply amount of hydrogen and air to the fuel cell 10.

On the other hand, when the electric power requested for the fuel cell 10 is high, the control device 100 controls the capacity of the air pump 32 and the opening degree of the fuel valve so as to increase the supply amount of hydrogen and air to the fuel cell 10.

When the electric power requested for the fuel cell 10 is high, a current flowing through the fuel cell 10 is large, and a load on the fuel cell 10 is high. At this time, with an increased heat generation amount of the fuel cell 10, the fuel cell 10 reaches a high temperature exceeding a target temperature Td.

Therefore, when a temperature difference ΔT between the target temperature Td of the fuel cell 10 and the temperature Tfc detected by the refrigerant temperature sensor 27 is equal to or greater than a predetermined value ΔTth1, the control unit 28 included in the control device 100 executes a temperature adjustment process of reducing the temperature difference ΔT. The temperature difference ΔT is an actual relative temperature of the fuel cell 10 with respect to the target temperature Td of the fuel cell 10. The temperature difference ΔT is an absolute value.

In the cooling system 20, the thermostat valve 26 has a temperature hysteresis characteristic, and thus a deviation is likely to occur between the temperature and the target temperature Td of the fuel cell 10. The temperature hysteresis characteristic means a characteristic in which a temperature at which the thermostat valve 26 switches the flow path for the refrigerant from the radiator 22 to the bypass flow channel 25 and a temperature at which the thermostat valve 26 switches the flow path for the refrigerant from the bypass flow channel 25 to the radiator 22 are different from each other.

The present inventors have verified a relationship between the temperature hysteresis characteristic of the thermostat valve 26 and a temperature change in the refrigerant. As a result of the verification, it is found that the temperature hysteresis characteristic of the thermostat valve 26 tends to vary according to the temperature change in the refrigerant.

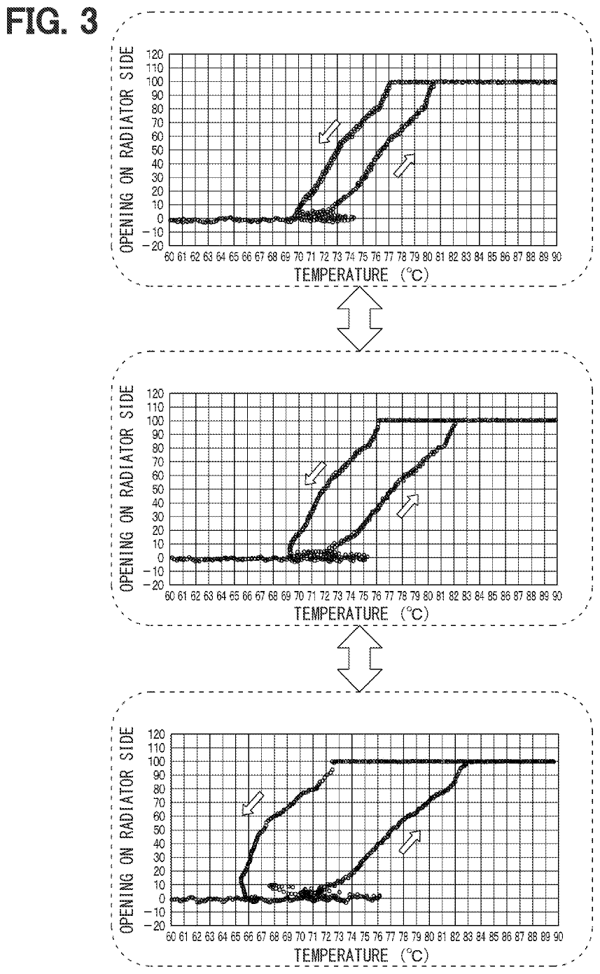

FIG. 3 illustrates the temperature hysteresis characteristic of the thermostat valve 26 obtained by the verification of the present inventors. An upper part in FIG. 3 illustrates the temperature hysteresis characteristic of the thermostat valve 26 when a change in the blowing capacity of the blower fan 23 is set to “small”. A middle part in FIG. 3 illustrates the temperature hysteresis characteristic of the thermostat valve 26 when the change in the blowing capacity of the blower fan 23 is set to “medium”. A lower part in FIG. 3 illustrates the temperature hysteresis characteristic of the thermostat valve 26 when the change in the blowing capacity of the blower fan 23 is set to “large”. For the temperature hysteresis characteristic illustrated in FIG. 3, a vertical axis represents an opening degree of the thermostat valve 26 on the radiator 22 side, and a horizontal axis represents a refrigerant temperature on an outlet side of the thermostat valve 26.

As illustrated in FIG. 3, it is found that the temperature hysteresis characteristic of the thermostat valve 26 tends to vary according to the temperature change in the refrigerant or the like. Specifically, when the change in the blowing capacity of the blower fan 23 is large and the temperature change in the refrigerant is rapid, a temperature difference (a so-called hysteresis width) between the temperature at which the thermostat valve 26 on the radiator 22 side is opened and the temperature at which the thermostat valve 26 on the radiator 22 side is closed tends to increase. When the change in the blowing capacity of the blower fan 23 is small and the temperature change in the refrigerant is slow, the hysteresis width tends to decrease.

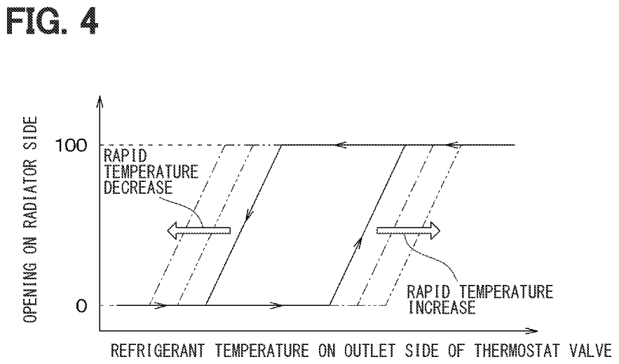

When the hysteresis width increases as indicated by dot-dash lines and two-dot chain lines in FIG. 4, the refrigerant temperature on the outlet side of the thermostat valve 26 deviates to a high-temperature side and a low-temperature side with respect to a case in which the hysteresis width indicated by solid lines in FIG. 4 decreases. Therefore, when the hysteresis width increases, the temperature difference between the fuel cell 10 and the refrigerant can be ensured, and a rapid temperature increase or a rapid temperature decrease of the fuel cell 10 can be expected as compared to the case in which the hysteresis width decreases.

In consideration of the above, when the temperature difference ΔT between the target temperature Td of the fuel cell 10 and the temperature Tfc detected by the refrigerant temperature sensor 27 is equal to or greater than the predetermined value ΔTth1, the control unit 28 according to the present embodiment reduces the temperature difference ΔT by changing the temperature hysteresis characteristic of the thermostat valve 26.

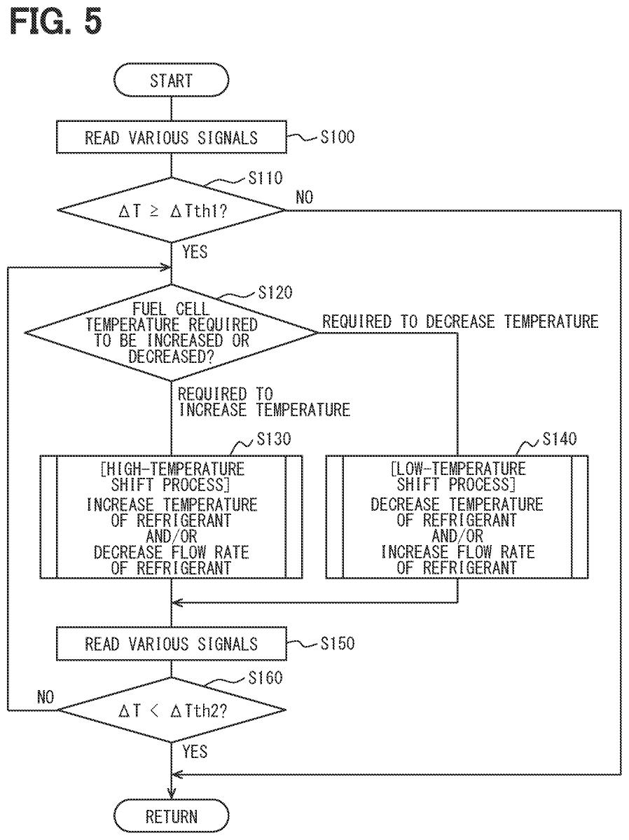

Hereinafter, the temperature adjustment process executed by the control unit 28 will be described with reference to FIG. 5. The temperature adjustment process illustrated in FIG. 5 is periodically or irregularly executed by the control unit 28 after the fuel cell 10 is activated.

As illustrated in FIG. 5, in step S100, the control unit 28 reads various signals via the devices connected to the input side of the control device 100 or the like. The control unit 28 reads, for example, the temperature Tfc detected by the refrigerant temperature sensor 27.

Subsequently, in step S110, the control unit 28 determines whether the temperature difference ΔT between the target temperature Td of the fuel cell 10 and the temperature Tfc detected by the refrigerant temperature sensor 27 is equal to or greater than the predetermined value ΔTth1.

In the fuel cell 10, a fine temperature adjustment of 2° C. to 3° C. is required from the viewpoint of ensuring power generation performance and restricting deterioration. Therefore, it is desirable to set the predetermined value ΔTth1 to 2° C. to 3° C.

When the temperature difference ΔT between the target temperature Td of the fuel cell 10 and the temperature Tfc detected by the refrigerant temperature sensor 27 is less than the predetermined value ΔTth1, the temperature of the fuel cell 10 is close to the target temperature Td, and thus the temperature adjustment for the fuel cell 10 is considered to be unnecessary. Therefore, when the temperature difference ΔT between the target temperature Td of the fuel cell 10 and the temperature Tfc detected by the refrigerant temperature sensor 27 is less than the predetermined value ΔTth1, the control unit 28 skips subsequent processes and exits the temperature adjustment process.

On the other hand, when the temperature difference ΔT between the target temperature Td of the fuel cell 10 and the temperature Tfc detected by the refrigerant temperature sensor 27 is equal to or greater than the predetermined value ΔTth1, the temperature of the fuel cell 10 remarkably deviates from the target temperature Td. Therefore, when the temperature difference ΔT between the target temperature Td of the fuel cell 10 and the temperature Tfc detected by the refrigerant temperature sensor 27 is equal to or greater than the predetermined value ΔTth1, the control unit 28 proceeds to a process in step S120.

In step S120, the control unit 28 determines whether the temperature of the fuel cell 10 is required to be increased or decreased. Specifically, when the temperature Tfc detected by the refrigerant temperature sensor 27 is lower than the target temperature Td of the fuel cell 10, the control unit 28 determines “required to increase temperature”. When the temperature Tfc detected by the refrigerant temperature sensor 27 is higher than the target temperature Td of the fuel cell 10, the control unit 28 determines “required to decrease temperature”.

When it is determined as “required to increase temperature” in a determination process in step S120, the control unit 28 executes a high-temperature shift process in step S130. The high-temperature shift process is a process of increasing a difference between the temperature at which the thermostat valve 26 on the radiator 22 side starts to be opened and the temperature at which the thermostat valve 26 on the radiator 22 side starts to be closed by performing at least one of a temperature increase and a flow rate decrease on the refrigerant flowing through the thermostat valve 26.

The temperature of the refrigerant flowing through the thermostat valve 26 can be increased by, for example, reducing the blowing capacity of the blower fan 23 and reducing a radiation capacity of the radiator 22. The flow rate of the refrigerant flowing through the thermostat valve 26 can be decreased by reducing a refrigerant discharge capacity of the refrigerant pump 24. A temperature increment of the refrigerant and a flow rate decrement of the refrigerant may be determined by, for example, referring to a control map that defines, in advance, a relationship among the temperature difference ΔT, the temperature hysteresis characteristic, the temperature increment of the refrigerant, and the flow rate decrement of the refrigerant, and the like.

When the high-temperature shift process is performed, the hysteresis width of the temperature hysteresis characteristic of the thermostat valve 26 increases according to the temperature change in the refrigerant. Accordingly, the refrigerant shifted to the high-temperature side is supplied to the fuel cell 10, and thus the temperature of the fuel cell 10 is increased.

On the other hand, when it is determined as “required to decrease temperature” in the determination process in step S120, the control unit 28 executes a low-temperature shift process in step S140. The low-temperature shift process is a process of increasing the difference between the temperature at which the thermostat valve 26 on the radiator 22 side starts to be opened and the temperature at which the thermostat valve 26 on the radiator 22 side starts to be closed by performing at least one of a temperature decrease and a flow rate increase on the refrigerant flowing through the thermostat valve 26.

The temperature of the refrigerant flowing through the thermostat valve 26 can be decreased by, for example, increasing the blowing capacity of the blower fan 23 and increasing the radiation capacity of the radiator 22. The flow rate of the refrigerant flowing through the thermostat valve 26 can be increased by increasing the refrigerant discharge capacity of the refrigerant pump 24. A temperature decrement of the refrigerant or a flow rate increment of the refrigerant may be determined by, for example, referring to a control map that defines, in advance, the relationship among the temperature difference ΔT, the temperature hysteresis characteristic, the temperature decrement of the refrigerant, and the flow rate increment of the refrigerant, and the like.

When the low-temperature shift process is performed, the hysteresis width of the temperature hysteresis characteristic of the thermostat valve 26 increases according to the temperature change in the refrigerant. Accordingly, the refrigerant shifted to the low-temperature side is supplied to the fuel cell 10, and thus the temperature of the fuel cell 10 is decreased.

Subsequently, in step S150, the control unit 28 reads various signals via the devices connected to the input side of the control device 100 or the like. The control unit 28 reads, for example, the temperature Tfc detected by the refrigerant temperature sensor 27.

Subsequently, in step S160, the control unit 28 determines whether the temperature difference ΔT between the target temperature Td of the fuel cell 10 and the temperature Tfc detected by the refrigerant temperature sensor 27 is less than a predetermined threshold ΔTth2. The threshold ΔTth2 is set to a value same as the predetermined value ΔTth1 or a value less than the predetermined value ΔTth1.

When the temperature difference ΔT between the target temperature Td of the fuel cell 10 and the temperature Tfc detected by the refrigerant temperature sensor 27 is less than the predetermined threshold ΔTth2, the temperature adjustment for the fuel cell 10 is considered to be unnecessary, and thus the control unit 28 exits the temperature adjustment process.

On the other hand, when the temperature difference ΔT between the target temperature Td of the fuel cell 10 and the temperature Tfc detected by the refrigerant temperature sensor 27 is equal to or greater than the predetermined threshold ΔTth2, the temperature adjustment for the fuel cell 10 is considered to be necessary, and thus the control unit 28 returns to the process in step S120.

In the above-described cooling system 20 for the fuel cell 10, when the temperature difference ΔT between the target temperature Td of the fuel cell 10 and the temperature Tfc detected by the refrigerant temperature sensor 27 is equal to or greater than the predetermined value ΔTth1, the control unit 28 executes the temperature adjustment process of reducing the temperature difference ΔT.

In this manner, with a configuration in which the temperature difference ΔT is reduced by changing the temperature hysteresis characteristic of the thermostat valve 26, complicated flow rate control using the thermostat valve 26 and the flow rate regulation valve as in the related art is unnecessary. Therefore, the temperature of the fuel cell 10 can be adjusted to a target temperature without complication. In other words, the temperature of the fuel cell 10 can be adjusted to the target temperature regardless of the presence or absence of a configuration corresponding to the flow rate regulation valve.

According to the present embodiment, the following effects can be obtained.
(1) In the temperature adjustment process, the control unit 28 changes the temperature hysteresis characteristic by changing at least one of the temperature and the flow rate of the refrigerant flowing through the thermostat valve 26. Accordingly, the temperature of the fuel cell 10 can be adjusted to a target temperature without performing complicated flow rate control using the flow rate regulation valve.
(2) When the target temperature Td of the fuel cell 10 is higher than the temperature Tfc detected by the refrigerant temperature sensor 27, the control unit 28 changes the temperature hysteresis characteristic by performing at least one of the temperature increase and the flow rate decrease on the refrigerant flowing through the thermostat valve 26 in the temperature adjustment process. Accordingly, the difference between the temperature at which the thermostat valve 26 on the radiator 22 side starts to be opened and the temperature at which the thermostat valve 26 on the radiator 22 side starts to be closed is increased, and thus the temperature of the fuel cell 10 can be easily increased to the target temperature Td, and the fuel cell 10 can be operated in an appropriate temperature range.
(3) When the target temperature Td of the fuel cell 10 is lower than the temperature Tfc detected by the refrigerant temperature sensor 27, the control unit 28 changes the temperature hysteresis characteristic by performing at least one of the temperature decrease and the flow rate increase on the refrigerant flowing through the thermostat valve 26 in the temperature adjustment process. Accordingly, the difference between the temperature at which the thermostat valve 26 on the radiator 22 side starts to be opened and the temperature at which the thermostat valve 26 on the radiator 22 side starts to be closed is increased, and thus the temperature of the fuel cell 10 can be easily decreased to the target temperature Td, and the fuel cell 10 can be operated in an appropriate temperature range.

### Second Embodiment

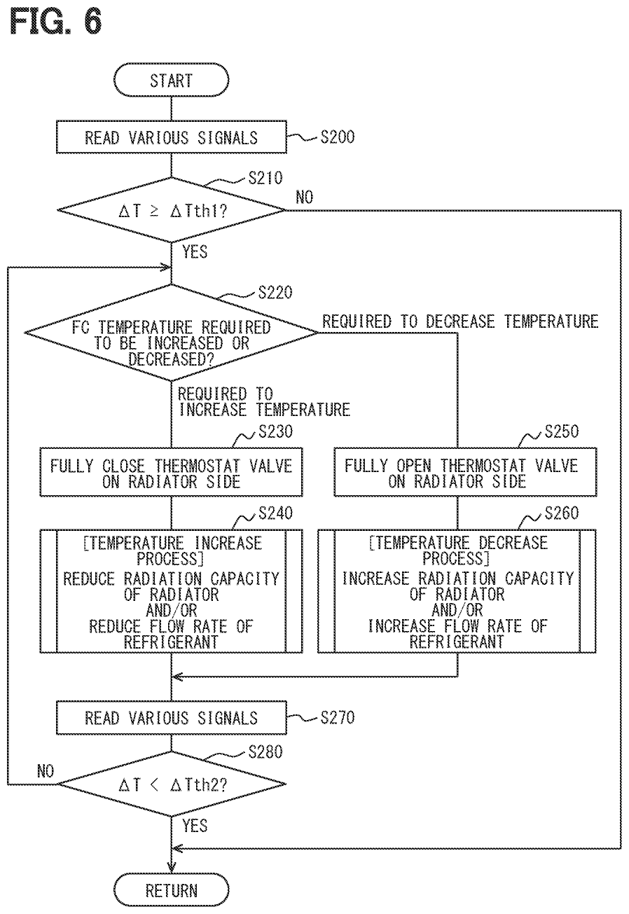

Next, a second embodiment will be described with reference to FIG. 6. In the present embodiment, parts different from the first embodiment will be mainly described.

In a cooling system 20 according to the present embodiment, contents of a temperature adjustment process executed by a control unit 28 are different from those according to the first embodiment. Hereinafter, the temperature adjustment process executed by the control unit 28 according to the present embodiment will be described with reference to FIG. 6. The temperature adjustment process illustrated in FIG. 6 is periodically or irregularly executed by the control unit 28 after a fuel cell 10 is activated. Processes in steps S200 to S220 illustrated in FIG. 6 are substantially the same as processes in steps S100 to S120 illustrated in FIG. 5.

As illustrated in FIG. 6, in step S200, the control unit 28 reads various signals via devices connected to an input side of the control device 100 or the like. The control unit 28 reads, for example, a temperature Tfc detected by a refrigerant temperature sensor 27.

Subsequently, in step S210, the control unit 28 determines whether a temperature difference ΔT between a target temperature Td of the fuel cell 10 and the temperature Tfc detected by the refrigerant temperature sensor 27 is equal to or greater than a predetermined value ΔTth1.

When the temperature difference ΔT between the target temperature Td of the fuel cell 10 and the temperature Tfc detected by the refrigerant temperature sensor 27 is less than the predetermined value ΔTth1, the control unit 28 skips subsequent processes and exits the temperature adjustment process.

On the other hand, when the temperature difference ΔT between the target temperature Td of the fuel cell 10 and the temperature Tfc detected by the refrigerant temperature sensor 27 is equal to or greater than the predetermined value ΔTth1, the control unit 28 proceeds to the process in step S220.

In step S220, the control unit 28 determines whether a temperature of the fuel cell 10 is required to be increased or decreased based on a comparison between the temperature Tfc detected by the refrigerant temperature sensor 27 and the target temperature Td of the fuel cell 10.

When it is determined as “required to increase temperature” in a determination process in step S220, the control unit 28 controls the devices so as to fully close a thermostat valve 26 on the radiator 22 side in step S230.

In order to fully close the thermostat valve 26 on the radiator 22 side, a temperature of a refrigerant flowing into the thermostat valve 26 may be decreased. Therefore, the control unit 28 increases, for example, a blowing capacity of a blower fan 23 or a refrigerant discharge capacity of a refrigerant pump 24 so as to decrease the temperature of the refrigerant flowing through the thermostat valve 26.

Thereafter, the control unit 28 performs a temperature increase process in step S240. The temperature increase process is a process of accelerating the temperature increase for the fuel cell 10 by reducing at least one of a radiation capacity of a radiator 22 and a flow rate of the refrigerant.

The radiation capacity of the radiator 22 can be reduced by, for example, reducing the blowing capacity of the blower fan 23. The flow rate of the refrigerant flowing through the thermostat valve 26 can be decreased by reducing a refrigerant discharge capacity of the refrigerant pump 24.

On the other hand, when it is determined as “required to decrease temperature” in the determination process in step S220, the control unit 28 controls the devices so as to fully open the thermostat valve 26 on the radiator 22 side in step S250.

In order to fully open the thermostat valve 26 on the radiator 22 side, the temperature of the refrigerant flowing into the thermostat valve 26 may be increased. Therefore, the control unit 28 reduces, for example, the blowing capacity of the blower fan 23 or the refrigerant discharge capacity of the refrigerant pump 24 so as to increase the temperature of the refrigerant flowing through the thermostat valve 26.

Thereafter, the control unit 28 performs a temperature decrease process in step S260. The temperature decrease process is a process of accelerating the temperature decrease of the fuel cell 10 by increasing at least one of the radiation capacity of the radiator 22 and the flow rate of the refrigerant.

The radiation capacity of the radiator 22 can be increased by, for example, increasing the blowing capacity of the blower fan 23. The flow rate of the refrigerant flowing through the thermostat valve 26 can be increased by increasing the refrigerant discharge capacity of the refrigerant pump 24.

Subsequently, in step S270, the control unit 28 reads various signals via the devices connected to the input side of the control device 100 or the like. The control unit 28 reads, for example, the temperature Tfc detected by the refrigerant temperature sensor 27.

Subsequently, in step S280, the control unit 28 determines whether the temperature difference ΔT between the target temperature Td of the fuel cell 10 and the temperature Tfc detected by the refrigerant temperature sensor 27 is less than a predetermined threshold ΔTth2. The threshold ΔTth2 is set to a value same as the predetermined value ΔTth1 or a value less than the predetermined value ΔTth1.

When the temperature difference ΔT between the target temperature Td of the fuel cell 10 and the temperature Tfc detected by the refrigerant temperature sensor 27 is less than the predetermined threshold ΔTth2, the temperature adjustment for the fuel cell 10 is considered to be unnecessary, and thus the control unit 28 exits the temperature adjustment process.

On the other hand, when the temperature difference ΔT between the target temperature Td of the fuel cell 10 and the temperature Tfc detected by the refrigerant temperature sensor 27 is equal to or greater than the predetermined threshold ΔTth2, the temperature adjustment of the fuel cell 10 is considered to be necessary, and thus the control unit 28 returns to the process in step S220.

The above-described cooling system 20 for the fuel cell 10 can obtain the same effects as those in the first embodiment, which are obtained by a common configuration or a configuration equivalent to that of the first embodiment. When the temperature difference ΔT between the target temperature Td of the fuel cell 10 and the temperature Tfc detected by the refrigerant temperature sensor 27 is equal to or greater than the predetermined value ΔTth1, the control unit 28 executes the temperature adjustment process of reducing the temperature difference ΔT after the thermostat valve 26 on the radiator 22 side is temporarily fully closed or fully opened.

In a state in which the thermostat valve 26 on the radiator 22 side is fully closed or fully opened, an influence of the temperature hysteresis characteristic of the thermostat valve 26 is reset, and thus the temperature of the fuel cell 10 is easily adjusted. Therefore, it is desirable to reduce the temperature difference ΔT between the target temperature Td and an actual temperature of the fuel cell 10, after the thermostat valve 26 on the radiator 22 side is temporarily fully closed or fully opened. Accordingly, complicated flow rate control using the thermostat valve 26 and a flow rate regulation valve as in the related art is unnecessary, and the temperature of the fuel cell 10 can be adjusted to a target temperature without complication.

According to the present embodiment, the following effects can be obtained.
(1) When the target temperature Td of the fuel cell 10 is higher than the temperature Tfc detected by the refrigerant temperature sensor 27, the control unit 28 temporarily decreases the temperature of the refrigerant flowing through the thermostat valve 26 and fully closes the thermostat valve 26 on the radiator 22 side in the temperature adjustment process. Thereafter, the control unit 28 reduces the temperature difference ΔT by reducing at least one of the radiation capacity of the radiator 22 and the flow rate of the refrigerant. Accordingly, the temperature of the fuel cell 10 can be easily increased to the target temperature Td, and the fuel cell 10 can be operated in an appropriate temperature range.
(2) When the target temperature Td of the fuel cell 10 is lower than the temperature Tfc detected by the refrigerant temperature sensor 27, the control unit 28 temporarily increases the temperature of the refrigerant flowing through the thermostat valve 26 and fully opens the thermostat valve 26 on the radiator 22 side in the temperature adjustment process. Thereafter, the control unit 28 reduces the temperature difference ΔT by increasing at least one of the radiation capacity of the radiator 22 and the flow rate of the refrigerant. Accordingly, the temperature of the fuel cell 10 can be easily decreased to the target temperature Td, and the fuel cell 10 can be operated in an appropriate temperature range.

### OTHER EMBODIMENTS

Although representative embodiments according to the present disclosure are described above, the present disclosure is not limited to the above-described embodiments, and various modifications can be made, for example, as follows.

As described above, it is desirable that the control unit 28 changes the temperature hysteresis characteristic of the thermostat valve 26 both when the target temperature Td of the fuel cell 10 is higher than the actual temperature and when the target temperature Td of the fuel cell 10 is lower than the actual temperature, but the present disclosure is not limited thereto. For example, the control unit 28 may change the temperature hysteresis characteristic of the thermostat valve 26 when the target temperature Td of the fuel cell 10 is higher than the actual temperature or when the target temperature Td of the fuel cell 10 is lower than the actual temperature.

The above-described cooling system 20 does not include a flow rate regulation valve for regulating the flow rate of the refrigerant passing through the fuel cell 10, but the present disclosure is not limited thereto. The flow rate regulation valve may be included.

In the above-described embodiments, an example is described in which the fuel cell system 1 according to the present disclosure is applied to the vehicle FCV, but the fuel cell system 1 according to the present disclosure can be applied to those other than the vehicle FCV.

In the above-described embodiments, it is needless to mention that elements forming the embodiments are not necessarily essential unless otherwise particularly specified as being essential or deemed as being apparently essential in principle.

In the above-described embodiments, the present disclosure is not limited to a specific number of components of the embodiments, except in a case in which numerical values such as the number of components, numerical values, quantities, ranges, and the like are referred to, particularly a case in which the numerical values are specified as being essential and a case in which the numerical values are apparently limited to the specific number in principle in principle, and the like.

In the above-described embodiments, when referring to the shape, positional relationship, and the like of a component and the like, the present disclosure is not limited to the shape, positional relationship, and the like, except in a case of being particularly specified, a case of being limited to a specific shape, a specific positional relationship in principle, and the like.

A control unit and a method thereof according to the present disclosure may be implemented by a dedicated computer provided by including a processor and a memory that are programmed to execute one or more functions embodied by a computer program. The control unit and the method thereof according to the present disclosure may be implemented by a dedicated computer provided by including a processor with one or more dedicated hardware logic circuits. The control unit and the method thereof according to the present disclosure may be implemented by one or more dedicated computers, each including a combination of a processor and a memory that are programmed to execute one or more functions and a processor formed of one or more hardware logic circuits. The computer program may be stored in a computer-readable non-transitory tangible recording medium as an instruction to be executed by a computer.

What is claimed is:

1. A cooling system for a fuel cell, comprising:
a refrigerant flow channel configured to allow a refrigerant, which is to cool a fuel cell, to flow therethrough;
a radiator configured to radiate heat from the refrigerant that has passed through the fuel cell;
a bypass flow channel configured to bypass the radiator and allow the refrigerant to flow therethrough;
a thermostat valve configured to select a flow path for the refrigerant between the radiator and the bypass flow channel according to a temperature of the refrigerant;
a refrigerant temperature sensor configured to measure a temperature of the refrigerant that has passed through the fuel cell; and
a control unit configured to execute, when a temperature difference between a target temperature of the fuel cell and a temperature detected by the refrigerant temperature sensor is equal to or greater than a predetermined value, a temperature adjustment process to change a temperature hysteresis characteristic of the thermostat valve to reduce the temperature difference.

2. The cooling system for a fuel cell according to claim 1, wherein
the control unit is configured to, in the temperature adjustment process, change the temperature hysteresis characteristic by changing at least one of the temperature of the refrigerant, which flows through the thermostat valve, and a flow rate of the refrigerant.

3. The cooling system for a fuel cell according to claim 1, wherein
the control unit is configured to, in the temperature adjustment process, when the target temperature of the fuel cell is higher than the temperature detected by the refrigerant temperature sensor, change the temperature hysteresis characteristic by performing at least one of a temperature increase or a flow rate decrease on the refrigerant flowing through the thermostat valve.

4. The cooling system for a fuel cell according to claim 1, wherein
the control unit is configured to, in the temperature adjustment process, when the target temperature of the fuel cell is lower than the temperature detected by the refrigerant temperature sensor, change the temperature hysteresis characteristic by performing at least one of a temperature decrease or a flow rate increase on the refrigerant flowing through the thermostat valve.

5. A cooling system for a fuel cell, comprising:
a refrigerant flow channel configured to allow a refrigerant, which is to cool a fuel cell, to flow therethrough;
a radiator configured to radiate heat from the refrigerant that has passed through the fuel cell;
a bypass flow channel configured to bypass the radiator and allow the refrigerant to flow therethrough;
a thermostat valve configured to select a flow path for the refrigerant between the radiator and the bypass flow channel according to a temperature of the refrigerant;
a refrigerant temperature sensor configured to measure the temperature of the refrigerant that has passed through the fuel cell; and
a control unit configured to, when a temperature difference between a target temperature of the fuel cell and a temperature detected by the refrigerant temperature sensor is equal to or greater than a predetermined value,
cause the thermostat valve on a radiator side to be temporarily fully closed or fully opened to reset an influence of a temperature hysteresis characteristic of the thermostat valve, and
thereafter, execute a temperature adjustment process to reduce the temperature difference.

6. The cooling system for a fuel cell according to claim 5, wherein
the control unit is configured, in the temperature adjustment process, when the target temperature of the fuel cell is higher than the temperature detected by the refrigerant temperature sensor,
cause the thermostat valve on the radiator side to be fully closed by temporarily decreasing the temperature of the refrigerant flowing through the thermostat valve, and
thereafter, reduce at least one of a radiation capacity of the radiator or a flow rate of the refrigerant to reduce the temperature difference.

7. The cooling system for a fuel cell according to claim 5, wherein
the control unit is configured, in the temperature adjustment process, when the target temperature of the fuel cell is lower than the temperature detected by the refrigerant temperature sensor,
cause the thermostat valve on the radiator side to be fully opened by temporarily increasing the temperature of the refrigerant flowing through the thermostat valve, and
thereafter, increase at least one of a radiation capacity of the radiator or a flow rate of the refrigerant to reduce the temperature difference.

8. A cooling system for a fuel cell, comprising:
a refrigerant flow channel configured to allow a refrigerant, which is to cool a fuel cell, to flow therethrough;
a radiator configured to radiate heat from the refrigerant that has passed through the fuel cell;
a bypass flow channel configured to bypass the radiator and allow the refrigerant to flow therethrough;
a thermostat valve configured to select a flow path for the refrigerant between the radiator and the bypass flow channel according to a temperature of the refrigerant;
a refrigerant temperature sensor configured to measure a temperature of the refrigerant that has passed through the fuel cell; and
a processor configured to execute, when a temperature difference between a target temperature of the fuel cell and a temperature detected by the refrigerant temperature sensor is equal to or greater than a predetermined value, a temperature adjustment process to change a temperature hysteresis characteristic of the thermostat valve to reduce the temperature difference.

9. A cooling system for a fuel cell, comprising:
a refrigerant flow channel configured to allow a refrigerant, which is to cool a fuel cell, to flow therethrough;
a radiator configured to radiate heat from the refrigerant that has passed through the fuel cell;
a bypass flow channel configured to bypass the radiator and allow the refrigerant to flow therethrough;
a thermostat valve configured to select a flow path for the refrigerant between the radiator and the bypass flow channel according to a temperature of the refrigerant;
a refrigerant temperature sensor configured to measure the temperature of the refrigerant that has passed through the fuel cell; and
a processor configured to, when a temperature difference between a target temperature of the fuel cell and a temperature detected by the refrigerant temperature sensor is equal to or greater than a predetermined value,
cause the thermostat valve on a radiator side to be temporarily fully closed or fully opened to reset an influence of a temperature hysteresis characteristic of the thermostat valve, and
thereafter, execute a temperature adjustment process to reduce the temperature difference.
